(19) United States
(12) Patent Application Publication
(10) Pub. No.: US 2019/0051939 A1
(43) Pub. Date: Feb. 14, 2019

(54) POLY(LITHIUM ACRYLATE) AND OTHER MATERIALS FOR MEMBRANES AND OTHER APPLICATIONS

(71) Applicant: Lionano Inc., Woburn, MA (US)

(72) Inventors: Peishen Huang, Woburn, MA (US); Minghui Li, Wilmington, MA (US); Yun Shen, Changshu (CN); Yingchao Yu, Cambridge, MA (US)

(73) Assignee: Lionano Inc., Woburn, MA (US)

(21) Appl. No.: 16/059,251

(22) Filed: Aug. 9, 2018

Related U.S. Application Data
(60) Provisional application No. 62/543,341, filed on Aug. 9, 2017.

(51) Int. Cl. H01M 10/0565; H01M 10/0525; H01M 2/16

(52) U.S. Cl. CPC H01M 10/0565; H01M 2300/0082; H01M 2/1653; H01M 10/0525

(57) ABSTRACT

The present invention generally relates to poly(lithium acrylate) (PLA) and other materials, which may be used in polymer blend membranes and other applications. Certain embodiments, for example, relate to methods of preparing poly(lithium acrylate), or membranes comprising poly(lithium acrylate). In some embodiments, lithium acrylate monomer may be obtained through neutralization reaction between a strong inorganic base and a weak organic acid. Such materials can be used in electrochemical cells, for example, as a membrane, e.g., for use in batteries such as lithium-ion batteries, or other applications. In certain cases, the molecular weight of the PLA may be between 10² Da to 10⁶ Da. In some embodiments, the membrane may have a mechanical strength of elastic stress modulus between 5 kPa to 500 MPa with strain from 0% to 200%. In some embodiments, the membrane may have an ionic conductivity between 10⁻⁹ S cm⁻¹ to 10⁻³ S cm⁻¹.

### RELATED APPLICATIONS

This application claims the benefit of U.S. Provisional Patent Application Ser. No. 62/543,341, filed Aug. 9, 2017, entitled “Poly(Lithium Acrylate) and Other Materials for membranes and Other Applications,” by Peishen Huang, et al., which is incorporated herein by reference in its entirety.

### FIELD

The present invention generally relates to poly(lithium acrylate) (PLA) and other materials, which may be used in polymer membranes and other applications. For example, the material can be used in electrochemical cells, for example, as a membrane, e.g., for use in batteries such as lithium-ion batteries, or other applications.

### BACKGROUND

The development of energy-dense and safe Li-ion batteries (LIBs) is important for addressing energy and environmental challenges, such as vehicle electrification and grid-level energy storage. Most state-of-the-art LIB configurations contain organic liquid electrolytes, which facilitate the movement of ions via the liquid's high ionic conductivity and offer the system a relatively high nominal voltage; however, the flammability of organic liquid electrolytes poses a safety hazard, especially in large or energy-dense systems. Furthermore, the energy density of state-of-the-art LIB s is significantly below that required for effective electric vehicle applications.

Acrylate polymers are noted for their transparency, resistance to breakage, feasible synthesis processes, and elasticity. They are commonly used in cosmetics, e.g. nail polish, as an adhesive. However, synthesis of acrylate polymers is limited by the neutralization of polyacrylic acids (PAA) by different hydroxides. Various challenges have hindered the processability, manufacturing compatibility, and commercial viability of such polymers. First, acrylic acid is more acidic than acetic acid; the low pH raises issues during polymerization, such as requiring corrosive-resistant reactors, limited polymerization methods, low compatibility with functionalized co-monomers, and restricted formulations for adjusting the properties of such polymers (e.g. polydispersity index (PDI), molecular weights, and copolymerization), for example. PAA also cannot be neutralized completely, due to the high viscosity of PAA aqueous solution. The acid-base equilibrium point of PAA is similar to its small molecule monomer (acrylic acid), but the unreacted acid sides on the polymer backbone and/or the extra metal hydroxide cannot be removed efficiently or completely at large scale. In addition, poor control over the molecular weight from traditional and limited polymerization methods results in an ionic polymeric product that is only suitable as a bulk, low-end material.

Furthermore, the molecular weight of polymeric materials is important to their physical properties and behavior. For example, the mechanical strength, solubility, glass transition temperature, and viscosity in solution can depend in part on the molecular weight. These properties may further influence the applied performance of the polymer materials. Practical methods that can effectively control of molecular weight of such polymers during synthesis have not been established. Given the advantages and challenges of such polymers, better synthesis techniques are needed.

### SUMMARY

The present invention generally relates to poly(lithium acrylate) (PLA) and other materials, which may be used in polymer membranes or other applications. For example, the material can be used in electrochemical cells, for example, as a membrane, e.g., for use in batteries such as lithium-ion batteries, or other applications. The subject matter of the present invention involves, in some cases, interrelated products, alternative solutions to a particular problem, and/or a plurality of different uses of one or more systems and/or articles.

In some aspects, the present invention is generally directed to poly(lithium acrylate) PLA polymers. PLA can be used, for example, as a solid electrolyte in a lithium-ion battery. In some aspects, the present invention is also directed to methods for preparing such material, to the precursors of such materials, and/or to solutions and/or membranes or films comprising such materials.

In some cases, PLA can be made using a precursor such as lithium acrylate (LA), which is an acrylic compound with ionic functional groups. LA can be obtained, for example, through an acid-base neutralization reaction with an excess of acrylic acid, which can be removed from the salt product during purification.

Direct polymerization of lithium acrylate may be used in some cases to produce PLA. This may avoid or reduce creating unreacted acid sites and/or incomplete purification.

In certain embodiments, radical polymerization may be used to prepare PLA. Radical polymerization may be performed in some cases with inert gas protection.

In some cases, the PLA polymer may have nanometer grains and/or millimeter flakes comprising various molecular weights, for example. In some embodiments, deionized water is used as a solvent. In certain embodiments, PLA can be precipitated at one or more times, which can be controlled, for example, by adjustments to the components in the mixed solvent.

In some embodiments, radical polymerization reactions may be initiated using one or more water soluble radical initiators. The solubility of the initiator may influence the reaction rate, molecular weights, and/or yields of the final products. The temperature of the reaction may be used in some cases to control the reaction rate.

In some embodiments, the PLA may have a distribution of molecular weights from 1,000 Da to 8,500 Da, inclusively. In some embodiments, the molecular weight of PLA can be controlled by carrying out the polymerization reaction in different solvents, e.g., because the solubility of polymer products varies in different solvents. For example, in some cases, the molecular weight may be controlled by controlling the solvent formulation. The viscosity of the polymer solution can be measured, for example, using a traditional glass tube viscometer. The Mark-Houwink equation can be used in some cases to establish a relationship between molecular weight and the viscosity.

In some aspects, PLA may have an electrochemical stability window inclusively ranging from −0.5 V to 5 V vs. Li, e.g., as determined using cyclic voltammetry or other similar techniques. PLA may exhibit a decomposition temperature of 180° C. to 250° C., inclusively, in some embodiments, e.g., as determined using thermogravimetric analysis or other similar techniques.

In another aspect, the present method encompasses methods of, or the manufacture of, a membrane containing PLA. In some embodiments, the elastic stress modulus of the membranes may be between 5 kPa to 500 MPa, inclusively. In some cases, the ionic conductivity of the membranes may be between 10⁻⁸ S cm⁻¹ to 10⁻³ S cm⁻¹.

In yet another aspect, the present invention is generally directed to an article. In one set of embodiments, the article comprises a membrane comprising a polyacrylate, a hydrophilic polymer, a salt, and a Lewis acid. The article, in another set of embodiments, comprises a poly(lithium acrylate), a hydrophilic polymer, a lithium salt, and a Lewis acid.

The present invention, in another aspect, is generally directed to an electrochemical device. According to one set of embodiments, the electrochemical device includes an anode, a cathode, and a solid electrolyte, where the solid electrolyte comprises poly(lithium acrylate), a hydrophilic polymer, a lithium salt, and a Lewis acid. The electrochemical device, in another set of embodiments, comprises an anode, a cathode, and a separator, wherein the separator comprises poly(lithium acrylate), a hydrophilic polymer, and a Lewis acid.

In still another aspect, the present invention is generally directed to a method. The method, in accordance with one set of embodiments, comprises exposing acrylic acid to a hydroxide base to produce an acrylic precursor.

In another aspect, the present invention encompasses methods of making one or more of the embodiments described herein, for example, PLA or membranes comprising PLA. In still another aspect, the present invention encompasses methods of using one or more of the embodiments described herein, for example, PLA or membranes comprising PLA.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a double extrapolation plot illustrating reduced viscosity and inherent viscosity against concentration, in accordance with one embodiment of the invention;

FIG. 2 illustrates the increase in molecular weight against the water content of the mixed solvent for polymer synthesis, in another embodiment of the invention;

FIGS. 3A-3B illustrate the differences in mechanical behaviors of two PLA-added polymer blend membranes with different molecular weights, in yet another embodiment of the invention;

FIGS. 4A-4B are Nyquist plots of PLA membranes activated by BF₃ additives, in still other embodiments of the invention; and

FIG. 5 illustrates a BS/IP/MSL capillary viscometer, in accordance with certain embodiments of the invention.

### DETAILED DESCRIPTION

The present invention generally relates to poly(lithium acrylate) (PLA) and other materials, which may be used in polymer blend membranes and other applications. Certain embodiments, for example, relate to methods of preparing poly(lithium acrylate), or membranes comprising poly(lithium acrylate). In some embodiments, lithium acrylate monomer may be obtained through neutralization reaction between a strong inorganic base and a weak organic acid. Such materials can be used in electrochemical cells, for example, as a membrane, e.g., for use in batteries such as lithium-ion batteries, or other applications. In certain cases, the molecular weight of the PLA may be between 10² Da to 10⁶ Da. In some embodiments, the membrane may have a mechanical strength of elastic stress modulus between 5 kPa to 500 MPa with strain from 0% to 200%. In some embodiments, the membrane may have an ionic conductivity between 10⁻⁹ S cm⁻¹ to 10⁻³ S cm⁻¹.

Some embodiments of the invention are generally directed to systems and methods of polymerizing lithium acrylate to form PLA.

In some embodiments, lithium acrylate monomer may be obtained through neutralization reaction between a strong inorganic base and a weak organic acid. In certain embodiments, the molar ratio of the acid and base can be defined, e.g., between lithium hydroxide and acrylic acid. For example, the molar ratio may be at least 1:1000, at least 1:500, at least 1:300, at least 1:200, at least 1:100, at least 1:50, at least 1:30, at least 1:20, at least 1:10, at least 1:5, at least 1:3, at least 1:2, at least 1:1, at least 2:1, at least 3:1, at least 5:1, at least 10:1, at least 20:1, at least 30:1, at least 50:1, at least 100:1, at least 200:1, at least 300:1, at least 500:1, or at least 1000:1. In some cases, the molar ratio may be no more than 1:1000, no more than 1:500, no more than 1:300, no more than 1:200, no more than 1:100, no more than 1:50, no more than 1:30, no more than 1:20, no more than 1:10, no more than 1:5, no more than 1:3, no more than 1:2, no more than 1:1, no more than 2:1, no more than 3:1, no more than 5:1, no more than 10:1, no more than 20:1, no more than 30:1, no more than 50:1, no more than 100:1, no more than 200:1, no more than 300:1, no more than 500:1, or no more than 1000:1. Combinations of any of these are also possible. For example, the molar ratio may be between 1:1 and 1:5, between 1:3 and 3:1, between 1:300 and 1:1, etc.

In some embodiments, PLA and other polyacrylates can be made into polymer membranes that function as a solid electrolyte in a LIB offering, for example, an enriched lithium ion environment, desirable modification of chemical structures, enhanced mechanical strength, and/or high ionic conductivity. Other applications of PLA in LIB s include acting as a binder or disperser for electrode fabrication.

Certain aspects of the present invention are generally directed to polyacrylates such as poly(lithium acrylate) (PLA), as well as systems and methods for making such polyacrylates. Poly(lithium acrylate) generally has a structure —(CH₂—CH(COO⁻Li⁺))ₙ—, and is commonly used in polymer membranes for use in applications such as for electrochemical cells, e.g., for use in batteries such as lithium-ion batteries.

It should be understood, however, that the present invention is not limited to only poly(lithium acrylate), but encompasses, in other embodiments, other polyacrylates as well, for example, polyacrylates comprising other alkali metals. Non-limiting examples include poly(sodium acrylate), —(CH₂—CH(COO⁻Na⁺))ₙ—, or poly(potassium acrylate), —(CH₂—CH(COO⁻K⁺))ₙ—. Accordingly, for any of the embodiments described herein using lithium, it should be understood that in other embodiments, other alkali metals, such as sodium and/or potassium, can also be present, instead of or in addition to lithium.

In one set of embodiments, the present invention is generally directed to methods of making polyacrylates such as poly(lithium acrylate) from an acrylic precursor with ionic functional groups. Such acrylic precursors may be prepared, for example, by reacting acrylic acid with a suitable base (e.g., LiOH, NaOH, KOH, etc.). The acrylic precursor may then be reacted with a suitable free radical initiator, such as 4,4′-azobis(4-cyanovaleric acid) (ACVA), to produce the polyacrylate. The polyacrylate can then be formulated within a membrane, for example, by casting the polyacrylate onto a suitable surface, e.g., a glass surface, a polymer surface, a metal surface, or the like.

Accordingly, in one aspect, the present invention is generally directed to systems and methods for making polyacrylates such as poly(lithium acrylate). In certain embodiments, the polyacrylates are prepared from acrylic precursors.

The acrylic precursors may be prepared, for example, by reacting acrylic acid with a suitable base. Acrylic acid an organic compound with the formula CH₂═CH—COOH. It can be readily obtained commercially. Examples of suitable bases include, but are not limited to, hydroxide bases such as lithium hydroxide (LiOH) (which can be used to produce lithium acrylate), sodium hydroxide (NaOH) (which can be used to produce sodium acrylate), potassium hydroxide (KOH) (which can be used to produce potassium acrylate), or the like. In some cases, more than one such base may be used, serially or simultaneously, e.g., to produce blends of different acrylic precursors. In some cases, the base may have a pH of at least 7, at least 8, at least 9, at least 10, at least 11, at least 12, or at least 13.

In some cases, the acrylic acid and the base may be reacted together within a solvent. For example, in some embodiments, water can be used as the solvent. The water may be deionized, or in some cases, the water can contain various additives, e.g., which are subsequently incorporated into the acrylic precursor and/or the final polyacrylate (e.g., chemically and/or physically incorporated). In addition, in some cases, other solvents may be used as well, such as ethanol.

The reaction between acrylic acid and the base can be highly exothermic. Accordingly, in some cases, the reaction may be performed under a controlled temperature. For example, in some embodiments, apparatuses, reagents, and/or reactants can be controlled to a temperature inclusively ranging from −50° C. to 80° C. For example, the temperature may be at least −50° C., at least −40° C., at least −30° C., at least −20° C., at least 10° C., at least 0° C., at least 10° C., at least 20° C., at least 30° C., at least 40° C., at least 50° C., at least 60° C., at least 70° C., etc., or no more than 80° C., no more than 70° C., no more than 60° C., no more than 50° C., no more than 40° C., no more than 30° C., no more than 20° C., no more than 10° C., no more than 0° C., no more than −10° C., no more than −20° C., no more than −30° C., no more than −40° C., etc. Combinations of any of these temperatures are also possible; for instance, the temperature may be kept between 20° C. and 40° C. Any suitable method of cooling may be used, for example, exposure to a cold bath, use of suitable refrigeration equipment, or the like.

In some embodiments, the length of the reaction time may be any time inclusively ranging from 0.1 minute (6 seconds) to 3 days. For example, the time may be at least 0.5 minutes, at least 1 minute, at least 2 minutes, at least 3 minutes, at least 5 minutes, at least 10 minutes, at least 15 minutes, at least 30 minutes, at least 1 hour, at least 2 hours, at least 3 hours, at least 6 hours, at least 12 hours, at least 24 hours, at least 48 hours, at least 72 hours, etc.

After reaction of the acrylic acid and the base to produce the acrylic precursor, in some embodiments, the acrylic precursor can be contained within a solvent, for example, to be filtered for impurities or side reactions. As an example, in one set of embodiments, the acrylic precursor can be dissolved in one or more polar-protic solvents. In some cases, a polar-protic solvents is an organic solvent with a relatively large dipole moment. For example, the dipole moment may be at least 0.10, at least 0.15, or at least 0.20 in various embodiments. This may be created, for example, by bonds between atoms within the solvent with different electronegativities, such as oxygen and nitrogen. In some cases, atoms such as oxygen and nitrogen may form bonds with hydrogens, and these O—H or N—H bonds can serve as a source of protons (H⁺). In some cases, the values for relatively polarity or dipole moment may be normalized from measurements of solvent shifts in the absorption spectra.

In some cases, two or more polar-protic solvents can be used. In some cases, the molar ratio of two of the polar-protic solvents may be at least 1:100, at least 1:50, at least 1:30, at least 1:20, at least 1:10, at least 1:5, at least 1:3, at least 1:2, at least 1:1, at least 2:1, at least 3:1, at least 5:1, at least 10:1, at least 20:1, at least 30:1, at least 50:1, or at least 100:1. In some cases, the molar ratio may be no more than 1:100, no more than 1:50, no more than 1:30, no more than 1:20, no more than 1:10, no more than 1:5, no more than 1:3, no more than 1:2, no more than 1:1, no more than 2:1, no more than 3:1, no more than 5:1, no more than 10:1, no more than 20:1, no more than 30:1, no more than 50:1, or no more than 100:1. Combinations of any of these are also possible. For example, the molar ratio may be between 1:10 and 10:1.

Polar-protic solvents include, but are not limited to: methanol, ethanol, water, propanol, iso-propanol, butanol, t-butanol, glycol, and glycerol. As mentioned, in some embodiments, more than one of these polar-protic solvents and/or other polar-protic solvents may be used.

In some embodiments, the solution can optionally be filtered to separate solid impurities, which cannot dissolve in the polar-protic solvent, and the filtrate can be collected. For example, the solution may be passed through a 1 micrometer filter, a 0.8 micrometer filter, a 0.45 micrometer filter, a 0.22 micrometer filter, a 0.2 micrometer filter, a 0.02 micrometer filter, or the like. Many such filters, such as syringe filters, are readily available commercially.

In certain embodiments, recrystallization may optionally be used to remove impurities from the acrylic precursor. Recrystallization is a process to separate pure solute from a bulk solution by adding another solvent, in which the certain solute holds very low solubility. In some embodiments, the acrylic precursor can be added to one or more polar-aprotic solvents. Polar-aprotic solvents include, but are not limited to: dichloromethane, tetrahydrofuran, acetone, dimethylether, dimethyl sulfoxide (DMSO), dimethylformamide (DMF), dimethylacetamide (DMAC), and N-methyl-2-pyrrolidone (NMP), and chloroform.

In some embodiments, the product of the recrystallization process may be separated from the solvent by any suitable technique, for example, by filtration and/or drying. Examples of filtration, but are not limited to, the following: hot filtration, in which a heated PLA solution reaches temperatures ranging from 20° C. to 100° C.; cold filtration, in which a cooled PLA solution reaches temperatures ranging from −80° C. to 20° C.; and vacuum filtration, in which a pressure gradient increases the rate of filtration.

Drying conditions can include, for example, any pressure (e.g., at ambient pressure, or at absolute pressures of less than 760 mmHg, less than 750 mmHg, less than 730 mmHg, less than 700 mmHg, less than 650 mmHg, less than 600 mmHg, less than 550 mmHg, less than 500 mmHg, less than 450 mmHg, less than 400 mmHg, less than 350 mmHg, less than 300 mmHg, less than 250 mmHg, less than 200 mmHg, less than 150 mmHg, less than 100 mmHg, less than 50 mmHg, less than 25 mmHg, less than 10 mmHg, etc.), and/or any suitable temperature. Examples of temperatures include, but are not limited to, at least 0° C., at least 10° C., at least 25° C., at least 50° C., at least 75° C., at least 100° C., at least 125° C., at least 150° C., at least 175° C., etc., or no more than 200° C., no more than 175° C., no more than 150° C., no more than 125° C., no more than 100° C., no more than 75° C., no more than 50° C., no more than 25° C., no more than 10° C., etc. Combinations of any of these are also possible in other embodiments. For instance, the temperature during drying may be between 100° C. and 150° C., or from 0° C. to 200° C.

As mentioned, certain aspects of the present invention are generally directed to polyacrylates such as poly(lithium acrylate), including systems and methods for making such polyacrylates. In one set of embodiments, such polyacrylates can be prepared using acrylic precursors such as lithium acrylate, which may be prepared as discussed above, or by other techniques. In addition, in some embodiments, acrylic precursors may be commercially obtained.

In one set of embodiments, an acrylic precursor such as lithium acrylate may be reacted with a suitable initiator to produce a polyacrylate such as poly(lithium acrylate). In some cases, this reaction may occur in a solvent. The solvent can be any organic solvent in which the acrylic precursor and the initiator can be dissolved. In some cases, the solvent may be a polar-protic solvent. Polar-protic solvents include, but are not limited to, methanol, ethanol, water, propanol, iso-propanol, butanol, t-butanol, glycol, and glycerol.

In addition, in certain embodiments, this reaction may occur under reduced pressures, and/or under degassing conditions, such as exposure to vacuum, sonication (e.g., by exposure to ultrasonic frequencies having an average frequency of at least 20 kHz), reaction under suitable gases such as argon and/or nitrogen (for example, in environments having no more than 20 vol %, no more than 15 vol % oxygen, no more than 10 vol %, or no more than 5 vol % oxygen), and/or by applying heating.

In some embodiments, the initiator can include one or more of following chemicals: benzoyl peroxide, 2,2′-azobisisobutyronitrile (AIBN), 4,4-azobis(4-cyanovaleric acid) (ACVA), potassium persulfate, or the like. Those of ordinary skill in the art will know of other initiators that can be used, in addition and/or in combination with these. Many initiators are readily obtainable commercially.

In some embodiments, the reaction between the acrylate and the initiator may be performed such that the purity of the product is at least 90%, at least 92%, at least 94%, at least 95%, at least 96%, at least 97%, or at least 98% by mass. In some cases, the yield of the reaction may be at least 80%, at least 85%, at least 90%, at least 92%, at least 94%, at least 95%, at least 96%, at least 97%, or at least 98%. The reaction may be performed in solvent in which the acrylate and the initiator can be dissolved. For example, the solvent may be a polar-protic solvent such as those disclosed herein.

In one set of embodiments, the molar ratio of initiator to acrylate may be at least 0.0001:1, at least 0.0003:1, at least 0.0005:1, at least 0.001:1, at least 0.003:1, at least 0.005:1, at least 0.01:1, at least 0.03:1, at least 0.05:1, at least 0.1:1, at least 0.3:1, at least 0.5:1, at least 1:1, etc. In some cases, the molar ratio may be no more than 2:1, no more than 1.5:1, no more than 1:1, no more than 0.5:1, no more than 0.3:1, no more than 0.1:1, no more than 0.05:1, no more than 0.03:1, no more than 0.01:1, no more than 0.005:1, no more than 0.003:1, no more than 0.001:1, no more than 0.0005:1, no more than 0.0003:1, or no more than 0.0001:1, etc. In certain embodiments, combinations of any of these ranges are also possible; for instance, the molar ratio of initiator to acrylate may be between 10⁻³:1 to 1:1.

The reactions can be performed at any suitable temperature and any suitable duration, depending on the formulations and the reaction conditions. For example, the temperature may be at least −20° C., at least −10° C., at least 0° C., at least 10° C., at least 20° C., at least 30° C., at least 40° C., at least 50° C., at least 60° C., at least 70° C., at least 80° C., at least 90° C., at least 100° C., at least 110° C., at least 120° C., at least 130° C., at least 140° C., at least 150° C., etc., and/or no more than 150° C., no more than 140° C., no more than 130° C., no more than 120° C., no more than 110° C., no more than 100° C., no more than 90° C., no more than 80° C., no more than 70° C., no more than 60° C., no more than 50° C., no more than 40° C., no more than 30° C., no more than 20° C., no more than 10° C., no more than 0° C., no more than −10° C., no more than −20° C., etc. Combinations of any of these temperatures are also possible. For instance, the temperature may be between 100° C. and 130° C. In addition, in some cases, the length of the reaction time may be any time inclusively ranging from 0.1 minute (6 seconds) to 3 days. For example, the time may be at least 0.5 minutes, at least 1 minute, at least 2 minutes, at least 3 minutes, at least 5 minutes, at least 10 minutes, at least 15 minutes, at least 30 minutes, at least 1 hour, at least 2 hours, at least 3 hours, at least 6 hours, at least 12 hours, at least 1 day, at least 2 days, at least 3 days, at least 4 days, at least 5 days, at least 6 days, at least a week, etc.

In some embodiments, the product may optionally be exposed to a non-solvent. This may be used, for example, to remove impurities. Non-solvents include, for example, hexane, cyclohexane, heptane, chloroform, dichloromethane, benzene, toluene, xylene, chlorobenzene, dichlorobenzene, as well as mixtures of these and/or other solvents. The product may be recovered in any suitable form, for example, as powder, flakes, glassy chunks, or the like.

In some embodiments, to control the molecular weight of PLA and other polyacrylates, monomer and initiator may be completely dissolved in a pure solvent, or a mixture of solvents in a given ratio. The solvent can either be pure or a mixture of any two or more polar-protic solvents, including any of the ratios of polar-protic solvents discussed herein. Increasing or decreasing the ratio of the solvents can be used in some cases to prepare PLA or other polyacrylates with various molecular weights. Polar-protic solvents include, but are not limited to, methanol, ethanol, water, propanol, iso-propanol, butanol, t-butanol, glycol, and glycerol. Results can be confirmed, for example, by viscosity measurements.

In certain embodiments, solutions can be degassed, for instance, using one or more of the following: application of vacuum, sonication, exposure to argon and/or nitrogen, and/or heating. The initiator may include one, or a mixture of, any of the following: benzoyl peroxide, 2,2′-azobisisobutyronitrile (AIBN), 4,4-azobis(4-cyanovaleric acid) (ACVA) and/or potassium persulfate (PP).

In some embodiments, the molar ratio between acrylate and solvent can be any number defined by g/(1−h−i), where g is the weight fraction of lithium acrylate, belonging to a numerical value ranging from 0 to 1; where h is the weight fraction of one polar-protic solvent, belonging to is a numerical value ranging from 0 to 1; and where i is the weight fraction of another polar-protic solvent, belonging to is a numerical value ranging from 0 to 1. In some cases, the molar ratio between acrylate and solvent may be at least 1:100, at least 1:50, at least 1:30, at least 1:20, at least 1:10, at least 1:5, at least 1:3, at least 1:2, at least 1:1, at least 2:1, at least 3:1, at least 5:1, at least 10:1, at least 20:1, at least 30:1, at least 50:1, or at least 100:1. In some cases, the molar ratio may be no more than 1:100, no more than 1:50, no more than 1:30, no more than 1:20, no more than 1:10, no more than 1:5, no more than 1:3, no more than 1:2, no more than 1:1, no more than 2:1, no more than 3:1, no more than 5:1, no more than 10:1, no more than 20:1, no more than 30:1, no more than 50:1, or no more than 100:1. Combinations of any of these are also possible.

The molar ratio of initiator and monomer, in certain embodiments can be any number defined by h+i=1−g. The molar ratio of initiator and monomer can be any number defined by 1/(j−1), where j is larger than 1. In some embodiments, the molar ratio between initiator and monomer may be at least 1:100, at least 1:50, at least 1:30, at least 1:20, at least 1:10, at least 1:5, at least 1:3, at least 1:2, at least 1:1, at least 2:1, at least 3:1, at least 5:1, at least 10:1, at least 20:1, at least 30:1, at least 50:1, or at least 100:1. In some cases, the molar ratio may be no more than 1:100, no more than 1:50, no more than 1:30, no more than 1:20, no more than 1:10, no more than 1:5, no more than 1:3, no more than 1:2, no more than 1:1, no more than 2:1, no more than 3:1, no more than 5:1, no more than 10:1, no more than 20:1, no more than 30:1, no more than 50:1, or no more than 100:1. Combinations of any of these are also possible.

The temperature range of the polymerization reactions can be any fixed number from −20° C. to 150° C. For example, the temperature may be at least −20° C., at least 10° C., at least 0° C., at least 10° C., at least 20° C., at least 30° C., at least 40° C., at least 50° C., at least 60° C., at least 70° C., at least 80° C., at least 90° C., at least 100° C., at least 110° C., at least 120° C., at least 130° C., at least 140° C., and/or no more than 150° C., no more than 140° C., no more than 130° C., no more than 120° C., no more than 110° C., no more than 100° C., no more than 90° C., no more than 80° C., no more than 70° C., no more than 60° C., no more than 50° C., no more than 40° C., no more than 30° C., no more than 20° C., no more than 10° C., no more than 0° C., or no more than −10° C. Combinations of any of these temperatures are also possible; for instance, the temperature may be between 100° C. and 150° C.

In some embodiments, the duration of the reaction can range from 0.1 min to 7 days. For example, the time may be at least 0.5 minutes, at least 1 minute, at least 2 minutes, at least 3 minutes, at least 5 minutes, at least 10 minutes, at least 15 minutes, at least 30 minutes, at least 1 hour, at least 2 hours, at least 3 hours, at least 6 hours, at least 12 hours, at least 24 hours, at least 48 hours, at least 72 hours, etc. The duration can depend, for example, on the reaction conditions, e.g., concentrations of the monomers, the targeted molecular weights of the products, and/or the solvents, etc.

Select non-solvent(s) can be used according to certain embodiments to remove impurities. Non-solvent(s) of ionic polymers contain one, or a mixture, of the following: hexane, cyclohexane, heptane, chloroform, dichloromethane, benzene, toluene, xylene, chlorobenzene, and/or dichlorobenzene. In some embodiments, a solid (manifesting in different forms, including powder, flacks, and/or glassy chunks) can be obtained as the final product. Drying conditions can include any of those discussed herein.

For example, in some embodiments, the drying conditions can include any pressure (e.g., at ambient pressure, or at absolute pressures of less than 760 mmHg, less than 750 mmHg, less than 730 mmHg, less than 700 mmHg, less than 650 mmHg, less than 600 mmHg, less than 550 mmHg, less than 500 mmHg, less than 450 mmHg, less than 400 mmHg, less than 350 mmHg, less than 300 mmHg, less than 250 mmHg, less than 200 mmHg, less than 150 mmHg, less than 100 mmHg, less than 50 mmHg, less than 25 mmHg, less than 10 mmHg, etc.), and/or any suitable temperature. Examples of suitable temperatures include, but are not limited to, at least 0° C., at least 10° C., at least 25° C., at least 50° C., at least 75° C., at least 100° C., at least 125° C., at least 150° C., at least 175° C., at least 200° C., at least 250° C., at least 300° C., at least 350° C., at least 400° C., at least 450° C., at least 500° C., etc., or no more than 600° C., no more than 500° C., no more than 450° C., no more than 400° C., no more than 350° C., no more than 300° C., no more than 250° C., no more than 200° C., no more than 175° C., no more than 150° C., no more than 125° C., no more than 100° C., no more than 75° C., no more than 50° C., no more than 25° C., no more than 10° C., etc. Combinations of any of these are also possible in other embodiments.

In certain embodiments, the molecular weights of PLA polymers can be controlled through the solubility of ionic polymers in pure or mixed solvents. Polymer products may be crushed out from the reaction mixture in different reaction times, dependent on the ratio of solvent to non-solvent. Formulations leading to early precipitations are designed for low molecular-weight products, whereas formulations that keep the polymer in solution for a relatively long time result in high molecular weight products. The propagation of polymer chains can happen only in the solution phase, with precipitation indicating the limit of polymer chain propagation. Crushed polymer chains cannot grow in length due to the loss of active radical sites.

In some embodiments, the polyacrylate product may have any suitable molecular weight. For instance, the molecular weight of the polyacrylate may be at least 100 Da, at least 200 Da, at least 300 Da, at least 500 Da, at least 750 Da, at least 1000 Da, at least 2000 Da, at least 3000 Da, at least 5000 Da, at least 7500 Da, at least 8500 Da, at least 10,000 Da, at least 20,000 Da, at least 30,000 Da, at least 50,000 Da, at least 75,000 Da, at least 100,000 Da, at least 200,000 Da, at least 300,000 Da, at least 500,000 Da, at least 750,000 Da, at least 1,000.00 Da, or the like. In some cases, the molecular weight may be no more than 1,000,000 Da, no more than 750,000 Da, no more than 500,000 Da, no more than 300,000 Da, no more than 200,000 Da, no more than 100,000 Da, no more than 75,000 Da, no more than 50,000 Da, no more than 30,000 Da, no more than 20,000 Da, no more than 10,000 Da, no more than 8500 Da, no more than 7500 Da, no more than 5000 Da, no more than 3000 Da, no more than 2000 Da, no more than 1000 Da, no more than 750 Da, no more than 500 Da, no more than 300 Da, no more than 200 Da, no more than 100 Da, etc. Combinations of any of these molecular weights are also possible; for example, the polyacrylate may have a distribution of molecular weights from 1,000 Da to 8,500 Da, inclusively. The molecular weights may be viscosity-averaged molecular weights (My), for example determined as discussed in the Examples below.

In certain aspects, the polyacrylate may be formed into various products such as films, polymer membranes, or the like. Polymer membranes can have versatile commercial and industrial applications, including, but not limited to: packaging, catalyst holders, filtration substrates, separators in batteries, solid polymer electrolytes, etc.

In some cases, a membrane or a film may be formed by casting a polyacrylate onto a suitable surface, e.g., a glass surface, a metal surface, a silicon surface, a silicon dioxide surface, a polymer surface (for instance, a polytetrafluoroethylene surface, a polycarbonate surface, a polypropylene surface, etc.), or the like. In some cases, once dried or hardened, the polyacrylate may take the shape or characteristics of the surface upon which it is positioned. Thus, for example, the thickness of the membrane may be controlled by controlling the amount or depth of material on the surface.

Various films or membranes can be achieved by varying formulations and conditions. For example, different molecular weights can be used to fabricate a membrane and achieve various binding efficiencies, mechanical properties, and/or electrochemical properties for broad applications. Examples of such molecular weight that can be used include those described above.

For example, in one set of embodiments, a polyacrylate may be dissolved in a solvent prior to casting as a film or membrane. In certain embodiments, a polyacrylate can be dissolved in one or more of the following solvents: dimethyl sulfoxide (DMSO), dimethylformamide (DMF), dimethylacetamide (DMAC), N-methyl-2-pyrrolidone (NMP), hexane, tetrahydrofuran, acetone, diethyl ether, n-butanol, t-butanol, propanol, ethanol, methanol, ethylene glycol, and/or glycerol. A mixture of different solvents can be used in some cases. Non-limiting examples of concentrations of the solution include at least 0.01 g/mL, at least 0.02 g/mL, at least 0.03 g/mL, at least 0.5 g/mL, at least 1 g/mL, at least 2 g/mL, at least 3 g/mL, or at least 5 g/mL of the polymer in solvent.

In some cases, the solvent may also include other polymers in addition to the polyacrylate. This may be useful, for example, in creating certain types of polymer blends. The polymers within the solvent may be present in any suitable ratio or concentration. Non-limiting examples of hydrophilic polymers include, but are not limited to: poly(N-isopropylacrylamide) (PNIPAM), polyacrylamide (PAM), poly(-oxazoline), polyethylenimine (PEI), poly(acrylic acid), polymethacrylate, poly(ethylene glycol), poly(ethylene oxide), poly(vinyl alcohol) (PVA) and its copolymers, poly(vinylpyrrolidone) (PVP) and its copolymers, or the like. Hydrophilic polymers may include polymers containing polar or charged atoms or functional groups, and/or those with relatively high solubility in water or polar solvents such as alcohols or DMSO (dimethyl sulfoxide).

In some embodiments, the solution containing the polyarcylate can be made under various temperatures (e.g., depending on the boiling points of the solvents that are used). For example, the temperature may be at least −20° C., at least −10° C., at least 0° C., at least 10° C., at least 20° C., at least 30° C., at least 40° C., at least 50° C., at least 60° C., at least 70° C., at least 80° C., at least 90° C., at least 100° C., at least 110° C., at least 120° C., at least 130° C., at least 140° C., at least 150° C., etc., and/or no more than 150° C., no more than 140° C., no more than 130° C., no more than 120° C., no more than 110° C., no more than 100° C., no more than 90° C., no more than 80° C., no more than 70° C., no more than 60° C., no more than 50° C., no more than 40° C., no more than 30° C., no more than 20° C., no more than 10° C., no more than 0° C., no more than −10° C., no more than −20° C., etc. Combinations of any of these temperatures are also possible. For instance, the temperature may be between 100° C. and 130° C. In some cases, the solution may be prepared using processes including, but not limited to, any of the following: sonication, magnetic string, mechanical string, and vibration mixing.

In addition, in another aspect, the present invention is generally directed to articles comprising a polyacrylate such as poly(lithium acrylate) and a salt such as a lithium salt. In some cases, the article may be a membrane or a film. In certain instances, such articles may be present within batteries or other electrochemical devices, such as lithium-ion batteries, e.g., used with anodes, cathodes, or other components within the battery or other electrochemical devices. For instance, articles such as those described herein may be used as electrolytes (e.g., solid-state electrolytes), as separators, or the like.

Examples of suitable salts include, but are not limited to lithium salts, sodium salts, potassium salts, and the like. One or more than one salt may be present. Lithium salts include, but are not limited to: lithium nitrate, lithium acetate, lithium bromide, lithium chloride, lithium perchlorate, lithium hexafluorophosphate, lithium hexafluoroarsenate, lithium trifluoromethanesulfonate, lithium tetrafluoroborate, and lithium bis(trifluoromethane)sulfonamide. Sodium salts include, but are not limited to: sodium nitrate, sodium acetate, sodium bromide, sodium chloride, sodium perchlorate, sodium hexafluorophosphate, sodium hexafluoroarsenate, sodium trifluoromethanesulfonate, sodium tetrafluoroborate, and sodium bis(trifluoromethane)sulfonamide. Potassium salts include, but are not limited to: potassium nitrate, potassium acetate, potassium bromide, potassium chloride, potassium perchlorate, potassium hexafluorophosphate, potassium hexafluoroarsenate, potassium trifluoromethanesulfonate, potassium tetrafluoroborate, and potassium bis(trifluoromethane) sulfonamide.

In some cases, the article may further comprise a Lewis acid. Lewis acids include, but are not limited to, one or a mixture of the following: borane trifluoride, borane trichloride, aluminum trifluoride, aluminum trichloride, and aluminum tribromide.

In one set of embodiments, the article may further comprise a polymer, such as a hydrophilic polymer. Examples of hydrophilic polymers include, but are not limited to: poly(N-isopropylacrylamide) (PNIPAM), polyacrylamide (PAM), poly(-oxazoline), polyethylenimine (PEI), poly(acrylic acid), polymethacrylate, poly(ethylene glycol), poly(ethylene oxide), poly(vinyl alcohol) (PVA) and its copolymers, poly(vinylpyrrolidone) (PVP) and its copolymers, or the like. Hydrophilic polymers are generally polymers containing polar or charged atoms or functional groups, and/or those with relatively high solubility in water or polar solvents such as alcohols or DMSO (dimethyl sulfoxide). In some cases, a hydrophilic polymer may contain polar or charged functional groups, rendering them soluble in water.

Thus, for example, in one set of embodiments, a hydrophilic polymer may have a solubility in water of at least 10⁻⁵ mg/ml, at least 10⁻⁴ mg/ml, or at least 10⁻³ mg/ml.

In some cases, the hydrophilic polymer may have a contact angle smaller than 90° (in contrast, a hydrophobic polymer may have a contact angle larger than 90°. The contact angle is the angle, measured through a water droplet, where the liquid surface of the water droplet meets a solid surface (e.g., of the polymer). Those of ordinary skill in the art will be aware of suitable techniques for measuring the contact angle of a polymer.

For example, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the article may comprise a polyacrylate, and/or no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt % of the article may comprise a polyacrylate.

Similarly, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the article may comprise one or more salts (e.g., lithium salts, sodium salts, potassium salts, etc.), and/or no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt % of the article may comprise one or more salts.

In some embodiments, at least 0.1 wt %, at least 0.3 wt %, at least 0.5 wt %, at least 1 wt %, at least 3 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the article may comprise one or more Lewis acids, and/or no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 3 wt %, no more than 1 wt %, no more than 0.5 wt %, no more than 0.3 wt %, or no more than 0.1 wt % of the article may comprise one or more Lewis acids.

In some embodiments, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the article may comprise one or more hydrophilic polymers, and/or no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt % of the article may comprise one or more hydrophilic polymers.

In addition, in certain embodiments, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 97 wt %, at least 98 wt %, at least 99 wt %, or substantially all of the article may comprise a polyacrylate (e.g., as discussed herein), a salt such as a lithium salt, a Lewis acid, and a hydrophilic polymer.

For example, in some embodiments, an article may comprise a polyacrylate such as poly(lithium acrylate), a hydrophilic polymer, a lithium salt, and a Lewis acid.

As a non-limiting example, in one set of embodiments, an article may comprise poly(lithium acrylate) at between 5 wt % and 35 wt %, a hydrophilic polymer at between 50 wt % and 75 wt %, a lithium salt at between 1 wt % and 15 wt %, and a Lewis acid at between 0.1 wt % and 5 wt %.

Each of these may independently be present in any suitable amount. In addition, in some cases, other components may be present within the article as well.

Membranes or films formed by such techniques may have certain desirable characteristics in certain embodiments. For example, in one set of embodiments, the material may exhibit relatively high ionic conductivities (e.g., at least 10⁻⁸ S/cm), and/or a relatively high elastic stress (Young's) modulus (e.g., at least 5 kPa). In addition, in some cases, the membrane may exhibit a relatively high decomposition temperature (e.g., at least 180° C.). In certain embodiments, the membrane may also exhibit an electrochemical stability window, such as discussed herein. Properties such as these may be useful, for example, in embodiments where the membrane is contained within a battery (e.g., a lithium-ion battery) or other electrochemical cell.

In some embodiments, for example, the mechanical strength modulation may be controlled via varying the molecular weight of polyacrylate. Examples of suitable molecular weights include those described above. In some embodiments, the polyacrylate may have an intrinsic ionic structure that exhibits behaviors such as glassy, hard, and/or brittle behavior. For example, the polyacrylate may have a hardness of at least 30, at least 40, at least 45, or at least 50 on the Rockwell hardness scale (e.g., ASTM E18).

In some cases, the mechanical strength modulation may be controlled by mixing the polyarcylate with other polymers, such as hydrophilic polymers, e.g., as described above. In some cases, for example, a membrane or film may have a mechanical strength of elastic stress of at least 5 kPa, at least 10 kPa, at least 20 kPa, at least 30 kPa, at least 50 kPa, at least 100 kPa, at least 200 kPa, at least 300 kPa, at least 500 kPa, at least 1 MPa, at least 2 MPa, at least 3 MPa, at least 5 MPa, at least 10 MPa, at least 20 MPa, at least 30 MPa, at least 50 MPa, at least 100 MPa, at least 200 MPa, at least 300 MPa, at least 500 MPa, etc. In addition, in some cases, the elastic stress may be less than 500 MPa, less than 300 MPa, less than 200 MPa, less than 100 MPa, less than 50 MPa, less than 30 MPa, less than 20 MPa, less than 10 MPa, less than 5 MPa, less than 3 MPa, less than 2 MPa, less than 1 MPa, less than 500 kPa, less than 300 kPa, less than 200 kPa, less than 100 kPa, less than 50 kPa, less than 30 kPa, less than 20 kPa, less than 10 kPa etc. In some cases, the membrane or film may have a mechanical strength between any of these, e.g., a membrane or film may be between 5 kPa and 500 MPa. In some cases, the mechanical strength may be determined using strains from 0% to 200%.

In some embodiments, polyacrylates can be used as plasticizers, e.g., to produce membranes with moderate strength but preferable strain. For example, the membrane may have a tensile strength of at least 1 MPa, at least 5 MPa, or at least 10 MPa and/or a tensile strain of at least 5%, at least 10%, or at least 15%.

In other embodiments, the polyacrylates can be mixed with other polymers to form rigid crystalline areas. For example, the rigid crystalline areas may have a Young's Modulus of at least 100 MPa, at least 500 MPa, at least 1 GPa, or at least 2 GPa.

In some cases, the membrane or film may exhibit ionic conductivities of at least 10⁻⁸ S/cm, at least 10⁻⁷ S/cm, at least 10⁻⁶ S/cm, at least 10⁻⁵ S/cm, at least 10⁴ S/cm, at least or at least 10⁻³ S/cm. The ionic conductivity can be determined using AC impedance measurements or other suitable techniques. One non-limiting example of such a technique is provided below in the Examples.

In some embodiments, the polyacrylate, as a lithium-ion containing material, can transport lithium ions under an electric field, e.g., within a battery or other electrochemical cell. Such materials for use within a battery or other electrochemical cell may also include, for example, lithium salts, Lewis acids, hydrophilic polymers, or method of claim B, wherein the he like.

Lewis acids include, but are not limited to, one or more of the following: borane trifluoride, borane trichloride, aluminum trifluoride, aluminum trichloride, aluminum tribromide, etc. Hydrophilic polymers include, but are not limited to, one or more of: polyethylene oxide, polyethylene glycol, polyethylene carbonate, polydimethylsiloxane, etc.

The following examples are intended to illustrate certain embodiments of the present invention, but do not exemplify the full scope of the invention.

### Example 1

In this example, lithium acrylate was obtained through a neutralization reaction between an inorganic strong base and an organic weak acid. 2 g acrylic acid was dissolved in 100 mL distilled H₂O. 0.63 g (0.95 molar ratio to acrylic acid) LiOH was added to the solution. The solution was cooled in an ice bath, then the reaction mixture was stirred for 5 minutes. Water was removed by rotary evaporation at 30° C. over 45 minutes.

### Example 2

50 g of synthesized crude product was dissolved in 25 mL of DI (deionized) water, resulting in a translucent solution. The solution was forced through a 0.2 micrometer syringe filter before being added to 100 mL acetone. After 2 hours, an organic salt was precipitated as a fine white powder and collected for further use.

### Example 3

Lithium acrylate (1 g), 4,4′-azobis(4-cyanovaleric acid) (ACVA) (0.0577 g) and MeOH/H₂O solvent (5/5 by volume, 11.5 mL) were mixed in a 20 mL vial. The mixture was degassed through freeze-pump-thaw cycles for five cycles. The reaction vial was sealed and stirred for 6 hours at 60° C. After reaction, acetone (10 mL) was added to the reaction vial and stirred for 15 minutes to precipitate poly(lithium acrylate) (PLA). The PLA was collected via vacuum filtration, and washed with isopropanol. The PLA was then dried in a vacuum oven at 50° C. over a period of 48 hours.

### Example 4

Sample preparation was performed as follows. 10 ml stock solutions of PLA were prepared with densities ranging from 10 mg/ml to 20 mg/ml using 10 ml volumetric flasks. Several sample solutions with densities ranging from 1 mg/ml to 8 mg/ml were prepared by diluting the stock solution using a 5 ml volumetric flask.

The viscometer was prepared as follows. A BS/IP/MSL capillary viscometer for transparent liquid (size 2) was cleaned with distilled water and acetone, then dried in an oven at 100° C. The dried viscometer was vertically aligned and secured with two clamps on a support stand. The verticality was confirmed by a torpedo level.

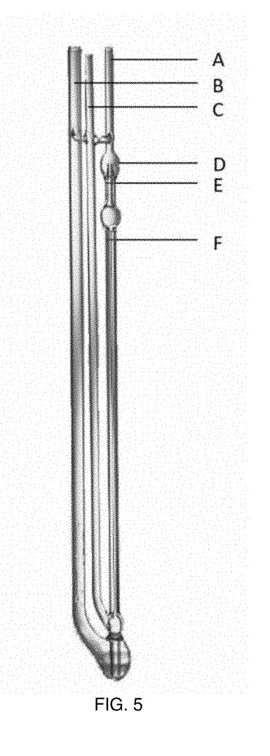

Measurements were performed using the viscometer schematically shown in FIG. 5 as follows:

1. A thermometer was placed next to the viscometer, as temperature has a significant effect on viscosity of liquid.

2. The viscometer was charged by introducing about 4 ml of sample solution into the lower reservoir through tube B.

3. A vacuum bulb was placed over tube C to adjust pressure and minimize measurement error, and suction was applied to tube A until liquid reached the center of bulb D. Suction was then removed from tube A while the vacuum bulb remained over tube C.

4. Efflux time was measured by allowing the liquid sample to flow freely down past mark E. The efflux time was recorded as the time elapsed between the liquid sample passing from mark E to mark F.

5. Steps 3 and 4 were repeated for replications.

Table 1 shows the viscosity measurements that were obtained.

TABLE 1

| | Relative | Specific | Reduced | Inherent |
|---|---|---|---|---|
| Concentration | Viscosity | Viscosity | Viscosity | Viscosity |
| (mg/mL) | (nᵣ) | (nₛₚ) | (n_{red}) | (nᵢₙₕ) |
| 0.003 | 2.403 | 1.404 | 467.895 | 292.334 |
| 0.00354 | 2.568 | 1.568 | 442.902 | 266.406 |
| 0.005 | 2.997 | 1.997 | 399.457 | 219.541 |

### Example 5

This calculation follows the equations shown in Example 9.

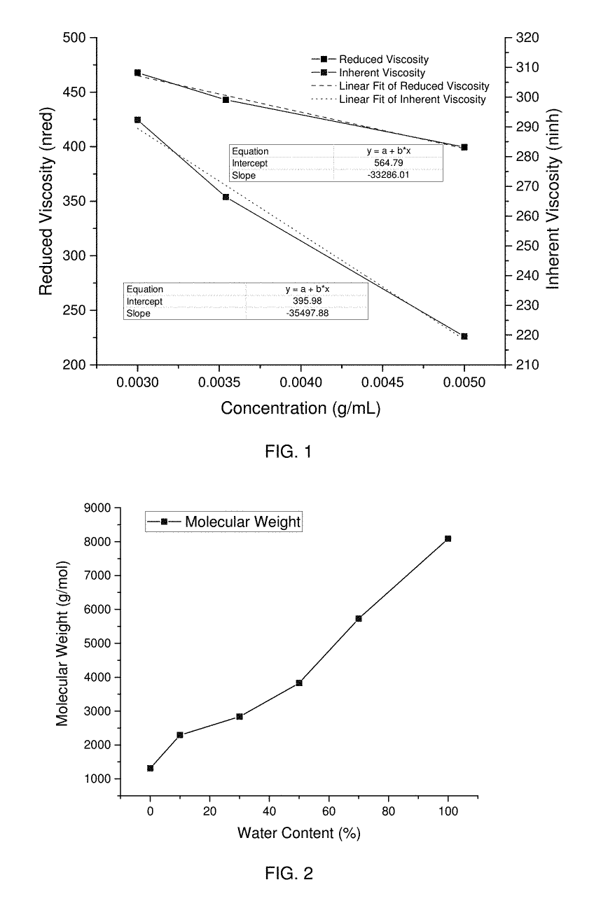

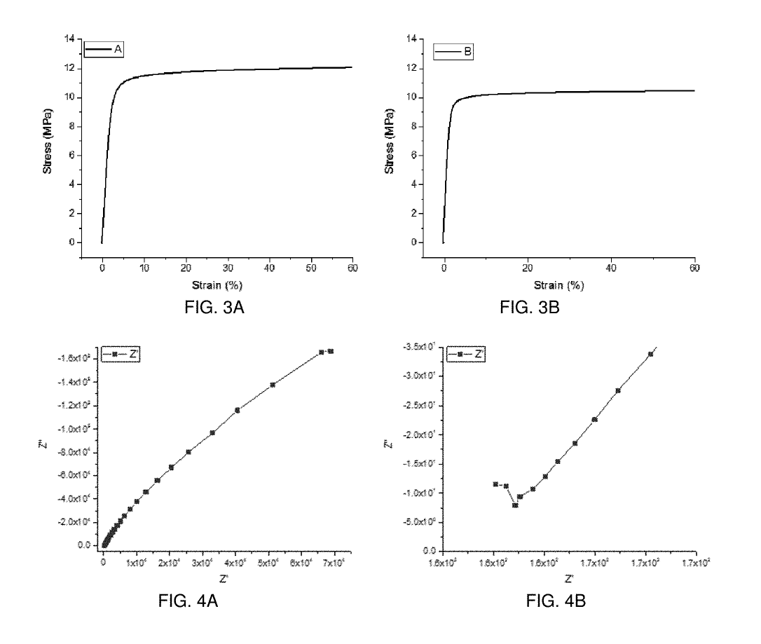

To calculate intrinsic viscosity, double extrapolation plots of reduced viscosity against concentration and inherent viscosity against concentration were plotted. The intrinsic viscosity was determined by the ordinate intercept of these graphs. The average molecular weight was calculated using Mark-Houwink equation (see FIG. 1). For these experiments, the intrinsic viscosity (ii, eta) was found to be 3105.03 mL/g (0.03105 dl/mg) and the average molecular weight was found to be 3829.1 g/mol. Note that when using the Mark-Houwink equation, the molecular weight that is calculated is the viscosity average molar weight (Mᵥ).

FIG. 2 shows a trend of increased molecular weight with a proportional increase in the percentage of water in the reaction solvent.

### Example 6

A PLA polymer blend membrane was prepared directly from solution casting in this example. 10 mL of a PLA polymer synthesized as discussed above in Example 3 was dissolved in water to a concentration of 0.5 M. A stock solution (water and DMSO (dimethyl sulfoxide), 10 mL, 1 M) of PEO (polyethylene oxide) with a molecular weight of 10⁶ Da were mixed with the PLA solution via stirring at 40° C. for 48 hours. A highly viscous solution was obtained, and cast on a flat glass plate. The solvents were evaporated under vacuum at −25 inHg pressure (i.e., below atmospheric pressure) at 70° C. for 48 hours. (1 inHg is about 3386.39 Pa.) A translucent, uniform, and smooth polymer membrane was obtained with a thickness around 200 micrometers.

### Example 7

A PLA sample was dissolved in PEO in water, and the viscous solution was directly cast onto a surface. The surface may be, for example, a glass surface, a PTFE (polytetrafluoroethylene) surface, an aluminum surface, or the like. After evaporating the solvent, the membrane was peeled off. A TA-Q800 DMTA instrument was used to measure the tensile strength and correlated modules of the film. The instrumental conditions are listed below, and Table 2 provides the polymer blend stiffnesses that were measured:

Temperature: −30 to 60° C.

Preload force: 0.001 to 6 N

Upper force: 6 to 12 N

Force ramp rate: 0.1 to 5 N/min

TABLE 2

| Polymer blend | Max stiffness (N/m) |
|---|---|
| PEO:PLA (1500 Da) | 2.6 × 10⁵ |
| PEO:PLA (8000 Da) | 9.6 × 10⁵ |

### Example 8

AC impedance measurements for the materials described above were obtained from a Solartron potentiostat with the following parameters:

Amplitude of DC bias: 300 mV

Amplitude of AC bias: 1 mV

AC frequency: 0.1-2×10⁴ Hz

The polymer electrolyte membrane was cast onto a stainless steel plate before being treated with an excess of pure BF₃. The membrane was cover by another stainless steel plate prior to measuring the impedance. Properties of the membrane were as follows:

Film thickness: 102 micrometers

Area: 1.92 cm²

Bulk resistance: 163 ohms, read from the Nyquist plot in FIG. 4.

Lithium ionic conductivity: 3.26×10⁻⁵ S cm⁻¹.

### Example 9

This example illustrates a relationship between viscosity and molecular weight of a PLA (poly(lithium acrylate) polymer, in accordance with certain embodiments of the invention. This relationship can be used, for example, to determine molecular weight using a viscometer.

The viscosity of PLA can be measured using a BS/IP/MSL viscometer. The viscometer may be charged with a proper amount of sample. Both efflux time of solvent (t₀) and solution (t) can be measured in the viscometer to calculate viscosity using the equations below:

$$Relative viscosity ( {η}_{r} ) \text{:} \frac{η}{{η}_{0}} = \frac{t}{{t}_{0}} = {η}_{r}$$

$$Inherent viscosity ( {η}_{inh} ) \text{:} \frac{ln {η}_{r}}{C} = {η}_{lnh}$$

$$Specific viscosity ( {η}_{sp} ) \text{:} \frac{η - {η}_{0}}{{η}_{0}} = \frac{t - {t}_{0}}{{t}_{0}} = {η}_{r} - 1 = {η}_{s ρ}$$

$$Reduced viscosity ( {η}_{red} ) : \frac{{η}_{s ρ}}{C} = {η}_{red}$$

The molecular weight can be estimated with the Mark-Houwink equation, which demonstrates that the molecular weight of a polymer sample can be estimated from an exponential relationship between intrinsic viscosity. The equation is shown below.

$$Intrinsic viscosity ( [ η ] ) \text{:} {( \frac{{η}_{s ρ}}{C} )}_{C \to 0} = {( \frac{ln {η}_{r}}{C} )}_{C \to 0} = [ η ] ,$$

where C is concentration of the polymer in solution.

The viscosity average molecular weight can then be calculated using Mark-Houwink equation:

[η]=KM^{α},

where [η] is intrinsic viscosity, M is viscosity average molecular weight, K and α are Mark-Houwink parameters for a particular solvents system. The solvent systems can be used to control molecular weight of PLA products during synthesis.

### Example 10

This example illustrates the determination of ionic conductivity using AC impedance measurements, in accordance with certain embodiments of the invention.

AC impedances were determined using Solartron or Gamry potentiostats with comparable parameters. AC and DC biases were in the range of 0.5 mV to 5 V. AC frequencies may be dependent on the output range of such instruments. Ionic conductivities (σ) were calculated by the equation:

σ=L/(A×R),

where R_{b} is the bulk resistances read from the Nyquest plots, L is the thickness, and A is the area of contacted surfaces between electrolyte and electrodes.

Blocking electrodes that can be used include copper, iron, stainless steel, aluminum and carbon paper.

Measurements were taken under temperatures from −20° C. to 60° C.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a membrane comprising a polyacrylate, a hydrophilic polymer, a salt, and a Lewis acid.

2. The article of claim 1, wherein the polyacrylate comprises poly(lithium acrylate).

3. The article of claim 1, wherein the salt comprises a lithium salt.

4. The article of claim 3, wherein the salt comprises lithium nitrate and/or lithium acetate and/or lithium bromide and/or lithium chloride and/or lithium perchlorate and/or lithium hexafluorophosphate and/or lithium hexafluoroarsenate and/or lithium trifluoromethanesulfonate and/or lithium tetrafluoroborate and/or lithium bis(trifluoromethane) sulfonamide.

5-13. (canceled)

14. The article of claim 1, wherein the hydrophilic polymer comprises poly(N-isopropylacrylamide) and/or polyacrylamide and/or poly(2-oxazoline) and/or polyethylenimine and/or poly(acrylic acid) and/or polymethacrylate and/or poly(ethylene glycol) and/or poly(vinyl alcohol) and/or poly(vinylpyrrolidone).

15-22. (canceled)

23. The article of claim 1, wherein the Lewis acid comprises borane trifluoride and/or borane trichloride and/or aluminum trifluoride and/or aluminum trichloride and/or aluminum tribromide.

24-27. (canceled)

28. The article of claim 1, wherein at least 80 wt % of the membrane comprises the polyacrylate, the hydrophilic polymer, the salt, and the Lewis acid.

29. The article of claim 1, wherein the membrane consists essentially of the polyacrylate, the hydrophilic polymer, the salt, and the Lewis acid.

30. The article of claim 1, wherein the membrane has a mechanical strength of elastic stress of at least 5 kPa with a strain from 0% to 200%.

31. The article of claim 1, wherein the polyacrylate has a molecular weight of at least about 100 Da.

32-34. (canceled)

35. The article of claim 1, wherein the membrane has an ionic conductivity of at least 10⁻⁹ S/cm.

36. The article of claim 1, wherein the membrane has an ionic conductivity of at least 10-8 S/cm.

37. The article of claim 1, wherein the membrane has an ionic conductivity of at least 10⁻⁷ S/cm.

38. The article of claim 1, wherein the membrane has an ionic conductivity of at least 10⁻⁶ S/cm.

39. The article of claim 1, wherein the membrane has an ionic conductivity of at least 10⁻⁵ S/cm.

40. The article of claim 1, wherein the membrane has an ionic conductivity of at least 10⁻⁴ S/cm.

41. The article of claim 1, wherein the article is an electrochemical device.

42. The article of claim 1, wherein the article is a battery.

43. The article of claim 42, wherein the membrane is a separator within the battery.

44. An electrochemical device, comprising:
an anode, a cathode, and a solid electrolyte, wherein the solid electrolyte comprises poly(lithium acrylate), a hydrophilic polymer, a lithium salt, and a Lewis acid.

45. The electrochemical device of claim 44, wherein the electrochemical device is a lithium-ion battery.

46. An electrochemical device, comprising:
an anode, a cathode, and a separator, wherein the separator comprises poly(lithium acrylate), a hydrophilic polymer, and a Lewis acid.

47. The electrochemical device of claim 46, wherein the electrochemical device is a lithium-ion battery.

48-102. (canceled)
